(19) United States
(12) Patent Application Publication
(10) Pub. No.: US 2011/0206950 A1
(43) Pub. Date: Aug. 25, 2011

(54) ENERGY STORAGE UNIT, PARTICULARLY ACCUMULATOR

(76) Inventor: Volker Doege, Dischingen (DE)

(21) Appl. No.: 12/672,197

(22) PCT Filed: May 9, 2008
(86) PCT No.: PCT/EP08/55782

§ 371 Date: Feb. 4, 2010

(30) Foreign Application Priority Data
Aug. 10, 2007 (DE) 10 2007 037 826.4
Aug. 31, 2007 (DE) 10 2007 041 526.7

(51) Int. Cl. H01M 16/00

(52) U.S. Cl. 429/9

(57) ABSTRACT

The building of energy storage, particularly accumulators have a plurality of storage elements such as electrochemical cells, condensers, BatCaps, and the like, out of similar elements connected to one another, is known. It is disadvantageous that the storage elements largely have either distinct high-energy properties or high-power properties. A potential improvement lies in the overall performance of the energy storage, and in optimally adjusting energy inputs to output power. An energy storage is proposed, particularly an accumulator, having a plurality of storage elements. At least two strands of storage elements are connected in parallel, each strand including at least one storage element of a certain type, differing from the type of the other strand. The energy storage according to the invention is intended for accumulator-driven or battery-drive electric tools and vehicle batteries, particularly for electric drives.

The present invention relates to an energy storage unit, in particular an accumulator, containing a plurality of storage elements.

It is known to construct energy storage units, in particular accumulators, which have a plurality of storage elements, such as electrochemical cells, capacitors, BatCaps and the like, always of identical elements wired to one another. It is disadvantageous that the storage elements usually have either pronounced high-energy properties or pronounced high-power properties. Examples that can be named are cell packs, capacitor banks, and the like. The wiring is effected by connecting the elements in series, in accordance with the operating voltage to be attained. Moreover, the requisite energy content and the required power data must be taken into account in the particular application. This type of energy storage unit, such as accumulators or batteries, are also, depending on the type of individual elements wired together, usually monitored for the requisite charging and discharging events by means of electrical and/or mechanical closed- and open-loop control circuits, so as to ensure safe, long-term operation of these energy storage units. One potential improvement is in the total performance of the energy storage units and the optimal adaptation of the energy content with the output power for the particular application.

### ADVANTAGES OF THE INVENTION

The energy storage unit of the invention, in particular an accumulator, has the advantage over the prior art of a pronounced improvement in the total performance of the energy storage unit, and this can be attained by simple means. Furthermore, optimal adaptation of the energy content to the output power of the energy storage unit can be attained. It is especially advantageous that the energy content of the entire energy storage unit can be increased substantially, resulting in a lengthening of the time in operation without having to make substantial high-power sacrifices in the application. The lengthening of the time in operation because of the greater energy content relates to the usage time (discharge cycle) of the charged energy storage unit until it is completely exhausted, but not to the number of charge and discharge cycles that can be performed. It is advantageous that means of the invention, a combination of different storage cell technologies is furnished, which can be put together quickly and effectively in modular fashion to make a complete energy storage unit, thus combining the specific advantages in the various modules. For example, high-current-capability electrochemical storage cells can be linked with storage cells of high energy contents. Advantageously, the overall arrangement then meets the power characteristics required for a special application, such as total again] energy content and electrical power output. It is advantageous that different storage elements or storage cells can be used in the energy storage unit or in the battery array and optimized for example for peak output or high-energy content.

Further advantages and advantageous features of the invention will become apparent from the independent claims and the description.

It is advantageous to use per phase A, B, a plurality of series-connected storage elements of the same type. Per phase A, B, for example, two, three or more series-connected storage elements can be used, and the number of storage elements in the phases A, B may be the same or different. If per phase A, B, a plurality of series-connected storage elements of the same type is provided, then advantageously the type of the storage element of the one phase is a high-power cell, and the other type of storage element of the other phase is a high-energy cell. The result is good overall energy storage unit performance, which meets the requirements for adequate capacity and maximum discharge current.

It is advantageous that the storage cells of the one phase A have a different chemical composition from the storage cells of the other phase B. The storage capacity of the individual phases A, B is different. Thus in a simple way, an energy storage unit that meets very different demands can be constructed in modular fashion.

It is highly advantageous that the parallel wiring is present at a plurality of points of the phases A, B, and for the parallel wiring of the phases A, B, at least one active or passive component is to provided. In particular, each storage cell of the one phase A is connected to the storage cell of the other phase B via the component. The result of the components is advantageously a good charge compensation between the phases, especially upon discharge, and in the periods rest, a charge compensation takes place in the direction of establishing the thermodynamic equilibrium of the overall arrangement. Advantageously, the component is a resistor whose resistance is in a range from approximately 50 mOhms to approximately 500 Ohms.

An arrangement in which the one phase A, as its storage elements, has four lithium cells as high-power cells HL, and the other phase B, as its storage elements, has four lithium cells as high-energy cells HE has proved to be very simple to furnish. In particular, the four lithium cells of phase A can be graphite/Li(NMC)O₂ 1.3 Ah/18650 HL, and the four lithium cells of phase B can be graphite/Li(NMC)O₂ 2.6 Ah/18650 HE.

Via three parallel-connected resistors, each storage cell of the one phase A is connected to the storage cell of the other phase B. Instead of four lithium cells per phase, more or fewer cells can be employed.

It is advantageous to employ a combination of lithium cells of different characteristics and/or different chemical composition per phase A; B. The storage capacity of the individual phases A, B differs because of the chemical composition and in particular the mechanical/physical cell construction. Thus an energy storage unit that meets quite different demands can be constructed in modular fashion in a simple way.

In an advantageous feature, the one phase A can have six high-power cells HL as its storage elements, and the other phase B can have five high-energy cells HE as it storage elements. In particular, the six lithium cells of phase A can be graphite/LiFePO₄ HL 1.2 Ah/18650 HL cells and the five lithium cells of phase B can be graphite/Li(NMC)O₂ 2.6 Ah/18650 HE.

It is advantageous to make a combination of lithium cells of different types. For instance, the four cells of phase A can be graphite/Li(NMC)O₂ pouch cell 1.55 Ah HL, and the four cells of phase B can be graphite/Li(NMC)O₂ 2.6 Ah/18650 HE cells. The advantage is that in principle even the most various forms of cell construction can be combined, with excellent performance. This is a degree of freedom that until now had never been utilized.

It is very simple and effective if a combination of high-power cells HL and high-energy cells HE of different technology is present. In particular, the one phase A can have three high-power cells HL and the other phase B can have a single high-energy cell HE. An effective embodiment is attained if the three high-power cells of phase A are NiMH HL 2.6 Ah/Sub-C, and the single high-energy cell of the other phase B is C/LiFePO₄ HE 2 Ah/18650. Here, the possibility exists of linking completely different cell systems to one another, such as nickel cells to lithium cells. In particular, there is a volumetric advantage over the use of only nickel cells. From the standpoint of the attainable charging algorithm as well, this combination is of great interest. Precisely in that way, even HE nickel cells could be combined with HL lithium cells.

It has proved to be successful if for the storage elements or the type for the particular phase A, B, a combination of the following types of storage element are used:
secondary lithium high-power cells, of the kind known for instance for use in power tools
secondary lithium high-energy cells, of the kind known for instance for use in portable personal computers, in which as lithium high-power cells and lithium high-energy cells, in particular lithium-ion cells, lithium polymer cells, including in combination with lithium-metal or alloy anodes and optional inorganic electrolyte solutions, are used
nickel-metal hydrides,
nickel-cadmium cells,
nickel/zinc secondary cells, and in the case of nickel cells, high-energy- and high-performance-optimized forms of cells can be used.

Moreover, as the storage elements for the particular phase A, B, the following types of storage elements can also be used:
double-layer capacitors
BatCaps.

It can also be accomplished in a simple and advantageous way to use commercially available forms for the storage elements, such as 18650, 26650, Sub-C, or any other standardized round cell housings, pouch cells, or in general prismatic geometries.

It is advantageous to provide more than two parallel phases. For instance, two high-power phases and one high-energy phase can be combined. It is also possible to combine two high-energy phases and one high-power phase. This can be done depending on the profile of demands made of the energy storage unit.

### DRAWINGS

Exemplary embodiments of the invention are described in further detail in the ensuing description and shown in further clarity in the drawings.

Shown are:

FIG. 1, a first and second exemplary embodiment of the energy storage unit, with four storage cells per phase;

FIG. 2, a third exemplary embodiment of the energy storage unit, with one phase having six storage cells and one phase having five storage cells;

FIG. 3, a fourth exemplary embodiment of the energy storage unit, with four storage cells per phase and with three parallel-connected resistors between the phases; and

FIG. 4, a fifth exemplary embodiment of the energy storage unit, with one phase having three storage cells and one phase having a single storage cell.

### EMBODIMENTS OF THE INVENTION

Present electrical energy storage units, such as accumulators or storage batteries, are characterized by the use of a single storage element of a specific type.

The storage element usually has either pronounced high-energy properties or pronounced high-power properties. A combination of the two properties has not yet been observed. According to the invention, it is now proposed that this disadvantage be overcome and that the specific positive properties of individual storage elements be combined. As the storage elements, cells or capacitors can be considered. According to the invention, there should be at least two parallel phases, and two or more different cell (and/or capacitor) technologies are linked, and from one to an arbitrary number of cells are connected in series.

At present, special lithium-ion high-power cells HL are for instance produced that are used particularly in electrically operated tools or so-called power tools. Special high-energy cells HE of the kind used in laptops are also known. These cells are used in the applications in only one form, as a kind of “varietal”. The high-energy cells HE have the disadvantage of making only low currents possible. Conversely, the high-power cells HL have the disadvantage that they have only a relatively low rated capacity.

Accordingly to the invention, a combination of different electrochemical and/or electrical storage elements into a single energy storage unit, accumulator, or total battery, is provided. The resultant overall arrangement is then intended to meet the power characteristics, such as total energy content (Wh) and electrical power output (capacity Ah), required for a special application. The advantage is now that different storage elements, which have each been optimized for peak power or high-energy content, can be used in the same arrangement or in the energy storage unit. Optionally, certain structural adaptations of the cell can be made for a specific use as a “hybrid pack”.

Until now, it has been possible only at major development effort, if at all, to make both a high specific power output and a high specific energy content possible for a specific storage unit technology, such as the accumulator or the capacitor. The invention furnishes a combination of different storage cell technologies which can be put together quickly and effectively in modular fashion to make a complete energy storage unit and thus combines the specific advantages of the various modules.

The invention aims at the construction of an energy storage unit 1 which is in the form of an accumulator or accumulator pack or a module, of the kind needed for supplying power particularly to cordless power tools or electrical vehicle drive systems. The invention can in principle also be extended to the combination of different classes of elements, such as accumulators, (super-) capacitors, BatCaps, or solar cells and fuel cells.

The construction of the energy storage unit or storage pack or rechargeable battery pack is done by means of a parallel wiring of individual or serially linked storage elements, such as rechargeable lithium-ion batteries. Hereinafter, lithium will be abbreviated as Li. Depending on the type of storage elements to be wired together, different wiring variants are permissible or necessary. It should be noted that the storage elements or types of storage elements cannot be allowed to be wired together in an arbitrary way. The energy storage unit or complete battery must be discarded in such a way that none of the storage elements are operated outside its product specifications, so as to make the maximum energy and power yields possible on the one hand and on the other to ensure safety in operation. With regard to the type of parallel wiring, the characteristic charge and discharge curves of the storage elements must therefore be taken into account, and the permitted voltage windows for operation must also be taken into account.

In FIG. 1, as an example, one possible construction of the energy storage unit 1 of the invention is shown in a first exemplary embodiment. There are two phases A, B of storage elements 10, 11, 12, 13 and 20, 21, 22, 23, which are wired in parallel. Each phase A; B has at least one storage element 10, 11, 12, 13 and 20, 21, 22, 23 of a certain type, which differs from the type of the other phase.

For phase A, there are four storage elements 10, 11, 12, 13 of one type, which are connected in series. For phase B, there are again four storage elements 20, 21, 22, 23 of one (different) type, which are connected in series. Per phase, there are accordingly a plurality of series-connected storage elements of the same type. Individually, for the storage elements 10, 11, 12, 13 of phase A, the type provided is graphite/Li(NMC)O₂ 1.3 Ah/18650 as high-power cells HL, and for the storage elements 20, 21, 22, 23 of phase B the type graphite/Li(NMC)O₂ 2.6 Ah/18650 as high-energy cells HE. Hence there is a combination of high-energy cells HE and high-power cells HE, of the kind used for power tool applications.

In principle, a combination of lithium (Li) cells of different construction is also possible. For instance, in a second exemplary embodiment, again in the circuit arrangement in FIG. 1, which for the four Li cells of phase A involves graphite/Li(NMC)O₂ HL pouch cell 1.55 Ah, and for the four Li cells of phase B involves graphite/Li(NMC)O₂ HE 2.6 Ah/18650.

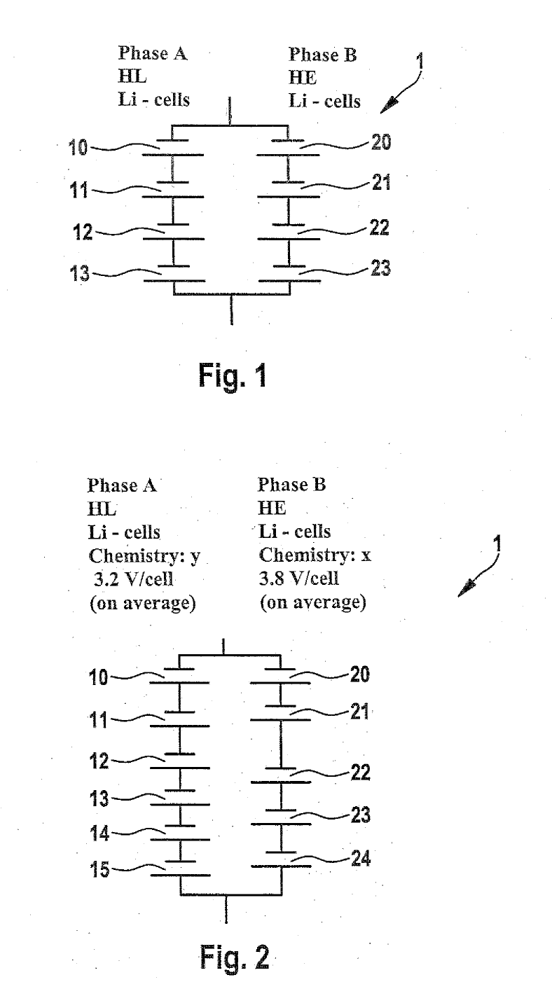

In principle, a combination of Li cells of different chemical composition is also possible. As shown in FIG. 2, in a third exemplary embodiment, for phase A there are for example six storage elements 10, 11, 12, 13, 14, 15, and for phase B there are for example five storage elements 20, 21, 22, 23, 24. The storage elements of each phase A and B are connected in series with one another. Per phase A; B, there are accordingly a plurality of series-connected storage elements of the same type. The one phase A has as its storage elements six high-power cells HL, and the other phase B has as its storage elements five high-energy cells HE. Individually, the six Li cells of phase A are graphite/LiFePO₄ HL 1.2 Ah/18650 cells, and the five Li cells of phase B are graphite/Li(NMC)O₂ 2.6 Ah/18650 HE. Each storage cell 10, 11, 12, 13, 14, 15 of phase A has for example 3.2 volts per cell, on average. Each storage cell 20, 21, 22, 23, 24 of phase B correspondingly has 3.8 volts per cell on average. This example applies to the parallel use of cells of a different voltage situation, and it follows that there is a different number of cells per phase. A parallel linkage of these phases is possible at the points where the individual cell voltages add up to approximately identical sums. In the example of FIG. 2, 6×3.8 volts of the HL, cell is approximately equal to 5×4.3 volts of charge termination voltage of the HE cell. In this pack unit, no parallel linkage within the six and five cells, respectively, in series is possible. It should be mentioned that the specific chemical mix of the cell is outlined only very roughly and as an example with graphite/Li(NMC)O₂ and merely recites the primary components. The precise material combinations are quite manifold in detail.

Besides the voltage-related balancing of the parallelized phase portions A, B, care must also be taken to attain the most homogeneous possible temperature distribution in the energy storage unit arrangement, so as not to allow the operating conditions of the individual storage elements to diverge from one another. Different temperature levels can cause differently pronounced aging processes and moreover change the contributions in terms of impedance and capacitance of the wired-together storage elements. Thus thermal homogenization also reduces the possible additively required electronic measurement and regulation effort and expense.

According to the invention, parallel-wired phases A, B are provided in which in each phase, storage elements of a certain type are present. The phases comprising one or more elements are linked electrically parallel at two or more points. The parallelization within the phases can be done in low-impedance fashion or by way of various passive and in general also active components. The term electrical passive component is understood to mean components that exhibit no amplifier effect, such as resistors. Active components are understood to be those that in some form exhibit an amplifier effect of the useful signal, such as transistors. The storage capacity of the individual phases A, B must have different values. The chemistry of high-power cells and high-energy cells can, but need not, differ from one another. However, the invention quite intentionally allows the linkage of cells of different chemistry. As a result, the electrical and safety-related properties of the modules can then be controlled in a targeted way. For instance, graphite/NMC oxide cells can be obtained which differ primarily in their mechanical construction and as a result in the end have high-power or high-energy properties. For example, in high-power cells, thicker diverters are used, and thinner active-mass coating thicknesses are attained, in order among other purposes to improve the electronic bond of the active masses and to reduce the diffusion lengths. The actual cell reaction, or in other words the chemistry of the cell, however, may be the same.

At the beginning of a discharging operation, the low-impedance high-power phase or phases are first loaded as a charge source. In the periods of rest between the individual discharging operations, a charge compensation will take place in the direction of establishing the thermodynamic equilibrium of the overall arrangement. As a result, the high-power phase is charged by means of charge carriers of the high-energy phase, and in subsequent discharges it can again make low-impedance electrical power available. The dimensioning of the high-power phases and high-energy phases of the overall arrangement is done on the basis of the particular load profiles and total energy quantities required. The selection of storage element types and the number and type of phases are oriented also to the impedance contribution, required for the specific application, in the parameter field of state of charge and temperature that has to be covered. Upon discharge, a charge compensation and/or voltage compensation need not necessarily occur between the phases. Theoretically, a complete separation of the phases during the discharge is also conceivable. A sufficient separation of the phases during the discharge is even appropriate, depending on the type of elements wired together. What is important is that the coupling component, within typical pause times (on the order of magnitude of from seconds to minutes) of the particular application, enable a cell voltage compensation or a thermodynamic equilibrium. In that time, the high-energy cell charges the high-power cell, until both cells have the same voltage. A resistor must then be selected for example in accordance with the desired time constants for the charge exchange.

The invention is not limited to the two phases A, B; three or more phases can also be used. In the respective total voltage, the number of parallel phases is determined by the required energy contents and current intensities. The lithium accumulators mentioned usually comprise no more than two phases. For example, two high-power phases can be combined with one high-energy phase, or vice versa. Three or more different phases are in principle conceivable as well and may be appropriate. For example, one high-power accumulator phase and one high-energy accumulator phase and one high-power capacitor phase, and so forth. In the exemplary embodiments, phase A is embodied for instance as a high-power phase, and phase B is embodied as a high-energy phase.

For the case in which the self-discharge of different storage elements used is different, and a critical undervoltage state can ensue, the voltage situation must be monitored constantly and regulating action taken as needed, for instance by decoupling individual phase portions. The effort and expense for electronic monitoring of individual and total voltages of the state of charge (SOC), the state of health (SOH), and any active balancing is oriented to the necessary performance and safety requirements. Depending on the storage cell type and on the overall concept of the energy storage unit or accumulator or battery pack, this effort and expense varies. Safety tests must confirm the safe operating state of all the concepts.

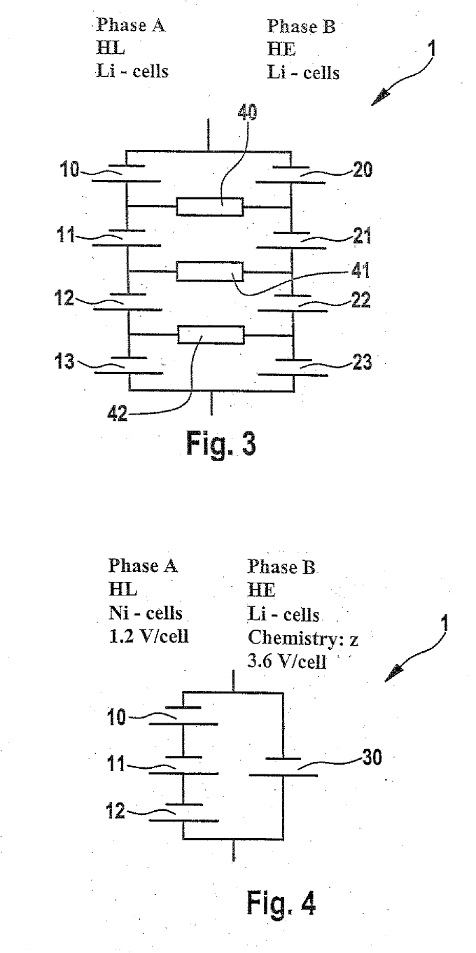

One example of parallelization within the phases A, B is shown in FIG. 3, which is a fourth exemplary embodiment. For the high-power phase A, there are for example four storage elements 10, 11, 12, 13, and for the high-energy phase B, there are again four storage elements 20, 21, 22, 23. Between the storage elements 10 and 11 of phase A, a resistor 40 is connected parallel to phase B between the storage elements 20 and 21. In the same way, between the storage elements 11 and 12 of phase A, a resistor 41 is connected parallel to the phase B between the storage elements 21 and 22. Between the storage elements 12 and 13 of phase A, a resistor 42 is connected parallel to the phase B between the storage elements 22 and 23.

Accordingly, there is a parallel wiring at a plurality of points of the phases A, B, and at least one active or passive component is provided for the parallel wiring of the phases A, B. Thus each storage cell of the one phase is connected to the storage cell of the other phase via the component. The at least one component may be an active or passive component, such as a transistor or a resistor. The resistor can be embodied in low-impedance fashion, and in any case is approximately greater than the internal cell resistance and less than or equal to what is as ascertained from calculating the time constant for the charge compensation. The result is a range from approximately 50 mOhms to approximately 500 Ohms. For commercially available 18650 lithium-ion cells, an order of magnitude of for instance 10⁻² Ohms to 10³ Ohms results. Precise estimates can be made for example from battery-pack-specific simulations, depending also on the particular application. As shown in FIG. 3, the one phase A, as its storage elements, has four lithium cells as high-power cells HL, and the other phase B, as its storage elements, has four lithium cells as high-energy cells HE. The four lithium cells of phase A can be graphite/Li(NMC)O₂ 1.3 Ah/18650 HL, and the four lithium cells of phase B can be graphite/Li(NMC)O₂ 2.6 Ah/18650 HE. Via the three resistors 40, 41, 42, additive parallel linkages of the phases A, B are obtained. The compensation currents possible as a result bring about additive parallelization with a positive effect on the service life of the accumulator pack 1. The resistance values should be markedly above the internal resistances of the individual storage elements, so as to prevent an asymmetrical discharge of the storage cells of the one phase.

In principle, particularly for a power tool application, a combination of high-energy and high-power cells is also possible, in which the storage cells have a different technology. For instance, in a further, fifth exemplary embodiment shown in FIG. 4, in which the energy storage unit in the one phase A is equipped with three high-power cells HL 10, 11, 12 and in another phase B with only a single high-energy cell HE 30. Individually, the three high-power cells 10, 11, 12 of phase A can be NiMH HL 2.6 Ah/Sub-C, and the single high-energy cell 30 of the other phase B can be C/LiFePO₄ HE 2 Ah/18650. Each storage cell 10, 11, 12 of phase A has 1.2 volts per cell, for example. The single storage cell 30 of phase B correspondingly has 3.6 volts.

In principle, there are no types of storage element that are precluded within the spectrum described. Only the electronic effort and expense for circuitry and regulation and naturally the total financial cost is decisive as to the use of individual energy storage unit constructions.

In particular, phases comprising the following types of storage element can be combined, such as:

a) secondary lithium high-power cells of a most various construction and fundamental chemical storage compounds. Among others, the following types of constructions can be considered: 18650, 26650, Sub-C, or all other standardized round cell housings, pouch cells, and prismatic geometries. As cell types, both lithium-ions, lithium-polymer, and storage cells with lithium metal and inorganic electrolyte solutions can be used. Electrochemically active substances can for instance be graphites, alloys, lithiizable metal oxides, phosphates, and sulfates;

b) secondary lithium high-energy cells of the most various construction, as described in a);

c) nickel-metal hydride storage cells of all constructions and forms;

d) nickel-cadmium storage cells of all constructions and forms;

e) nickel/zinc secondary cells;

f) double-layer capacitors; and

g) BatCaps, which in a cell have combined contributions comprising Faraday processes, double-layer capacitors, and/or capacitive dielectric contributions.

The examples on the basis of secondary lithium cells for simple energy storage unit constructions or accumulator constructions or battery constructions according to the invention are described in the exemplary embodiments.

The energy storage unit of the invention is intended for accumulator-operated or battery-operated electric tools and vehicle batteries, especially for electric drive systems.

1-14. (canceled)

15. An energy storage unit, in particular an accumulator, containing a plurality of storage elements, and having at least two phases of storage elements present, which are wired in parallel, wherein one phase has at least one storage element of a certain type, which differs from a type of storage element of an other phase.

16. The energy storage unit as defined by claim 15, wherein per phase, a plurality of series-connected storage elements of a same type are present.

17. The energy storage unit as defined by claim 15, wherein the certain type of the storage element of one phase is a high-power cell, and the type of storage element of the other phase is a high-energy cell.

18. The energy storage unit as defined by claim 16, wherein the certain type of the storage element of one phase is a high-power cell, and the type of storage element of the other phase is a high-energy cell.

19. The energy storage unit as defined by claim 17, wherein the storage cells of the one phase have a different chemical composition from the storage cells of the other phase.

20. The energy storage unit as defined by claim 18, wherein the storage cells of the one phase have a different chemical composition from the storage cells of the other phase.

21. The energy storage unit as defined by claim 17, wherein storage capacity of individual phases is different.

22. The energy storage unit as defined by claim 19, wherein storage capacity of individual phases is different.

23. The energy storage unit as defined by claim 14, wherein parallel wiring is present at a plurality of points of the phases, and for the parallel wiring of the phases, at least one active or passive component is provided.

24. The energy storage unit as defined by claim 23, wherein each storage cell of the one phase is connected to the storage cell of the other phase via the at component.

25. The energy storage unit as defined by claim 23, wherein the component is a resistor, which is particularly in the range from approximately 50 mOhms to approximately 500 Ohms.

26. The energy storage unit as defined by claim 24, wherein the component is a resistor, which is particularly in the range from approximately 50 mOhms to approximately 500 Ohms.

27. The energy storage unit as defined by claim 17, wherein one phase, as its storage elements, has at least one lithium cell as high-power cells, and the other phase, as its storage elements, has at least one lithium cell as high-energy cells.

28. The energy storage unit as defined by claim 23, wherein each storage cell of the one phase is connected to the storage cell of the other phase via three parallel-connected resistors.

29. The energy storage unit as defined by claim 26, wherein each storage cell of the one phase is connected to the storage cell of the other phase via three parallel-connected resistors.

30. The energy storage unit as defined by claim 27, wherein each storage cell of the one phase is connected to the storage cell of the other phase via three parallel-connected resistors.

31. The energy storage unit as defined by claim 17, wherein a combination of lithium cells of different chemical composition is present per phase.

32. The energy storage unit as defined by claim 14, wherein the storage elements, for a particular phase is a combination of the following types of storage elements:
secondary lithium high-power cells;
secondary lithium high-energy cells, in which as secondary lithium high-power cells and secondary lithium high-energy cells, lithium-ion cells, lithium polymer cells, including in combination with lithium-metal or alloy anodes and inorganic electrolyte solutions;
nickel-metal hydrides;
nickel-cadmium cells;
nickel/zinc secondary cells;
double-layer capacitors; and
BatCaps.

33. The energy storage unit as defined by claim 14, wherein two high-power phases and one high-energy phase are present.

34. The energy storage unit as defined by claim 14, wherein two high-energy phases and one high-power phase are present.
